(19) United States
(12) Patent Application Publication
(10) Pub. No.: US 2013/0254242 A1
(43) Pub. Date: Sep. 26, 2013

(54) DATABASE PROCESSING DEVICE, DATABASE PROCESSING METHOD, AND RECORDING MEDIUM

(71) Applicants: Takehiko KASHIWAGI, Tokyo (JP); Junpei KAMIMURA, Tokyo (JP)

(72) Inventors: Takehiko KASHIWAGI, Tokyo (JP); Junpei KAMIMURA, Tokyo (JP)

(73) Assignee: NEC Corporation, Tokyo (JP)

(21) Appl. No.: 13/829,034

(22) Filed: Mar. 14, 2013

(30) Foreign Application Priority Data
Mar. 26, 2012 (JP) 2012-069026
Nov. 26, 2012 (JP) 2012-257359

(51) Int. Cl. G06F 17/30

(52) U.S. Cl. CPC G06F 17/30312
USPC 707/812

(57) ABSTRACT

The database processing device includes: a column store database including a storage into which tuple data is stored in a unit of a column and a management structuring section into which first information indicative of a valid data range and second information including identification information of data that is already invalid are stored in terms of the storage; and a database processing section that, when performing a process of inserting data for the column store database, additionally affixes the data to an end of the storage to update the first information of the management structuring section, and when performing a process of deleting data for the column store database, additionally affixes identification information of deletion-target data to the second information of the management structuring section.

### INCORPORATION BY REFERENCE

This application is based upon and claims the benefit of priority from Japanese patent application No. 2012-069026, filed on Mar. 26, 2012 and Japanese patent application No. 2012-257359, filed on Nov. 26, 2012, the disclosure of which is incorporated herein in its entirety by reference.

### BACKGROUND OF THE INVENTION

The present invention relates to a database processing device for processing a column store database, a method therefor, and a recording medium therefor.

There exists a column store database that manages data in a unit of a column. The column store database has developed as a read only storage such as a batch storage and DWH (Data Ware House); however the technology that enables high-speed/large-volume write and high-speed/parallel read by applying this column store database to an OLTP (On-line Transaction Processing) work load as well is required due to a request for reducing cost of a memory, multi-coring a CPU, and analyzing real-time data at a high speed. For example, the technology of preventing degradation of performance due to additional processing of data in the column store database is described in JP-P2011-209807A, being Patent Literature.

When data is rewritten with the column store database, it is necessary to rewrite data and to cancel the lock on top of locking all columns or all lines so as to prevent mismatching between columns from being accompanied, and taking a control so as to prevent read queries from being simultaneously performed. For this, a read query cannot be performed while a write query is performed. Further, there is a tendency that the processing becomes slow due to frequent occurrence of a cache miss because the write query demands alteration of various locations within a memory or a disk.

The present invention has been accomplished in consideration of the above-mentioned problems, and an object thereof is to provide a database processing device that enables the high-speed write and parallelism of the read in the column store database to be enhanced, a method therefor, a recording medium therefor, and the like.

### SUMMARY OF THE INVENTION

The present invention is a database processing device that is characterized in including a column store database including a storage into which tuple data is stored in a unit of a column and a management structuring section into which first information indicative of a valid data range and second information comprised of identification information of data that is already invalid are stored in terms of the aforementioned storage, and a database processing section that, when performing a process of inserting data for the aforementioned column store database, additionally affixes the aforementioned data to an end of the aforementioned storage and updates the aforementioned first information of the aforementioned management structuring section, and when performing a process of deleting data for the aforementioned column store database, additionally affixes identification information of delete-target data to the aforementioned second information of the aforementioned management structuring section.

The present invention is a database processing method that is characterized in, when performing a process of inserting data for a column store database including a storage into which tuple data is stored in a unit of a column and a management structuring section into which first information indicative of a valid data range and second information comprised of identification information of data that is already invalid are stored in terms of the aforementioned storage, additionally affixing the aforementioned data to an end of the aforementioned storage and updating the aforementioned first information of the aforementioned management structuring section, and when performing a process of deleting data for the aforementioned column store database, additionally affixing identification information of delete-target data to the aforementioned second information of the management structuring section.

The present invention is a non-transitory computer readable storage medium having a program stored therein for causing a computer to execute a process of, when performing a process of inserting data for a column store database including a storage into which tuple data is stored in a unit of a column and a management structuring section into which first information indicative of a valid data range and second information comprised of identification information that is already invalid are stored in terms of the aforementioned storage, additionally affixing the aforementioned data to an end of the aforementioned storage and updating the aforementioned first information of the aforementioned management structuring section, and a process of, when performing a process of deleting data for the aforementioned column store database, additionally affixing identification information of delete-target data to the aforementioned second information of the aforementioned management structuring section.

The present invention is a data structure of a column store database including a storage into which tuple data is stored in a unit of a column and a management structuring section into which first information indicative of a valid data range and second information comprised of identification information that is already invalid are stored in terms of the aforementioned storage.

The present invention makes it possible to enhance the high-speed write and parallelism of the read in the column store database.

### BRIEF DESCRIPTION OF THE DRAWINGS

This and other objects, features, and advantages of the present invention will become more apparent upon a reading of the following detailed description and drawings, in which:

FIG. 1 is a view illustrating a configuration of the database processing device relating to a first exemplary embodiment of the present invention;

FIG. 2 is a view illustrating a structure of the database relating to the first exemplary embodiment of the present invention;

FIG. 3 is a view for specifically explaining an inserting process of the first exemplary embodiment;

FIG. 4 is a view for specifically explaining a deleting process of the first exemplary embodiment;

FIG. 5 is a view for specifically explaining an updating process of the first exemplary embodiment;

FIG. 6 is a view for specifically explaining a finding process of the first exemplary embodiment;

FIG. 7 is a flowchart for explaining the finding process of the first exemplary embodiment;

FIG. 8 is a view illustrating a configuration of the database processing device relating to a second exemplary embodiment of the present invention;

FIG. 9 is a view illustrating a structure of the database relating to the second exemplary embodiment of the present invention;

FIG. 10 is a view for specifically explaining the inserting process of the second exemplary embodiment;

FIG. 11 is a view for specifically explaining the deleting process of the second exemplary embodiment;

FIG. 12 is a view for specifically explaining the updating process of the second exemplary embodiment;

FIG. 13 is a view for specifically explaining the finding process of the second exemplary embodiment; and

FIG. 14 is a flowchart for explaining the finding process of the second exemplary embodiment.

### EXEMPLARY EMBODIMENTS

Hereinafter, the exemplary embodiments of the present invention will be explained by referring to the accompanied drawings.

### First Exemplary Embodiment

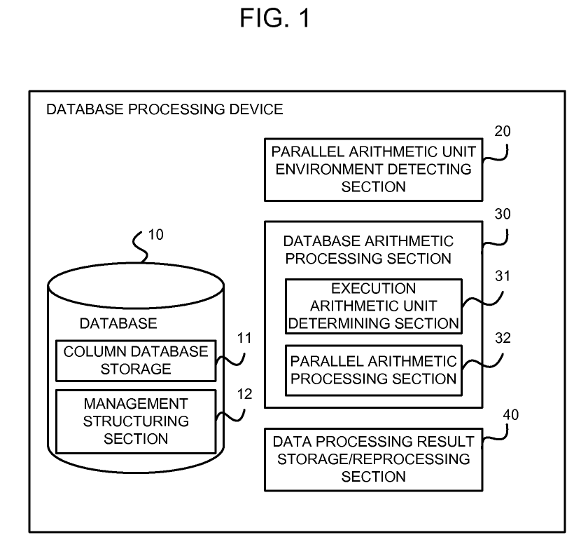

FIG. 1 is a view illustrating a configuration of the database processing device relating to the first exemplary embodiment of the present invention. The database processing device, which is configured of a computer including a CPU (Central Processing Unit), a parallel arithmetic unit such as a GPU (Graphics Processing Unit), and a storing section etc. The database processing device includes a database 10, a parallel arithmetic unit environment detecting section 20, a database arithmetic processing section 30, and a data processing result storage/reprocessing section 40 as shown in FIG. 1.

The database 10 is a column store database. A unit of management of the database is configured of a tuple, a column, a table and a schema, each of which can be stored in a plural number into a high-ranked structure. The tuple contains data of a certain line inside the database. The data of a specific column are collected inside a certain column store in a unit of the tuple. The data to be stored into the database 10 could be fixed-length data or variable-length data.

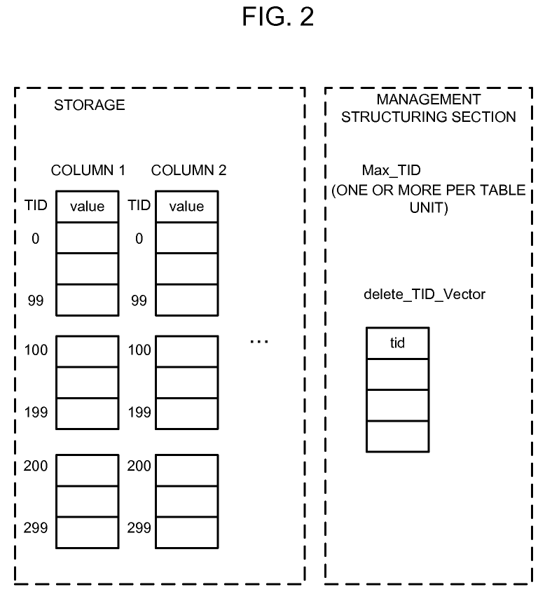

A structure of the database 10 is exemplified in FIG. 2. As shown in the figure, the database 10 includes a column database (storage) 11 in which only the additional affixing is permitted, and a management structuring section 12 for management in a unit of the table. The management structuring section 12 stores data of a latest tuple position (max_TID) indicative of the position to be regarded as valid at a certain time point, and data of a deleted tuple array (delete_TID_Vector) indicative of an array of tuple IDs deleted so far as identification information of the tuples that are already invalid. The aforementioned database arithmetic processing section 30 decides an exclusive control range for the column store database that is employed at the time of updating the column store database, based on information stored into the management structuring section 12.

The parallel arithmetic unit environment detecting section 20 acquires, for example, information (a unit of the data processes and the like) associated with a processing ability of the parallel arithmetic unit in this device.

The database arithmetic processing section 30 includes an execution arithmetic unit determining section 31 and a parallel arithmetic processing section 32. The execution arithmetic unit determining section 31 determines whether the requested computation process is a process suitable for the parallel arithmetic unit, and determines which arithmetic unit (the CPU and the GPU) is used to execute an arithmetic process based on a set determination result. For example, when the requested arithmetic process corresponds to any set arithmetic processes, the execution arithmetic unit determining section 31 may determine that the parallel arithmetic unit is employed on top of previously setting the arithmetic processes (a filter arithmetic operation to the column storage and the like) that can be performed at a high speed by using the parallel arithmetic unit. Further, the execution arithmetic unit determining section 31 may be adapted to acquire information of a use rate of the parallel arithmetic unit, to determine that the requested arithmetic process is performed with the CPU when the use rate is higher than a threshold, and to instruct its effect. When the execution arithmetic unit determining section 31 determines the use of the parallel arithmetic unit, the parallel arithmetic processing section 32 causes the parallel arithmetic unit to execute various arithmetic processes.

The data processing result storing/reprocessing section 40 stores/processes the arithmetic result by the database arithmetic processing section 30.

Next, an operation of the database processing device relating to this exemplary embodiment will be explained. Processes to be performed for the database 10 are insertion (INSERT) of data, deletion (DELETE), updating (UPDATE), finding (FIND), computation for the finding result (Func), and re-processing (INSERT, DELETE, UPDATE).

The inserting process (INSERT) will be explained. The database arithmetic processing section 30 issues to the storage 11 TIDs (tuple IDs) of which number is identical to the number of data to be newly inserted, and additionally affixes data to an end of the storage. And, when the additional affixing of the tuples to all columns for which the additional affixing should be performed is completed, the database arithmetic processing section 30 updates the latest tuple position max_TID of the management structuring section 12 with a value obtained by performing the addition by the number equivalent to the number of the data for which the additional affixing should be performed. At this time, data having TID smaller than the old max_TID is not altered, whereby other database processes such as the finding and the data deletion relating hereto can be performed simultaneously in parallel.

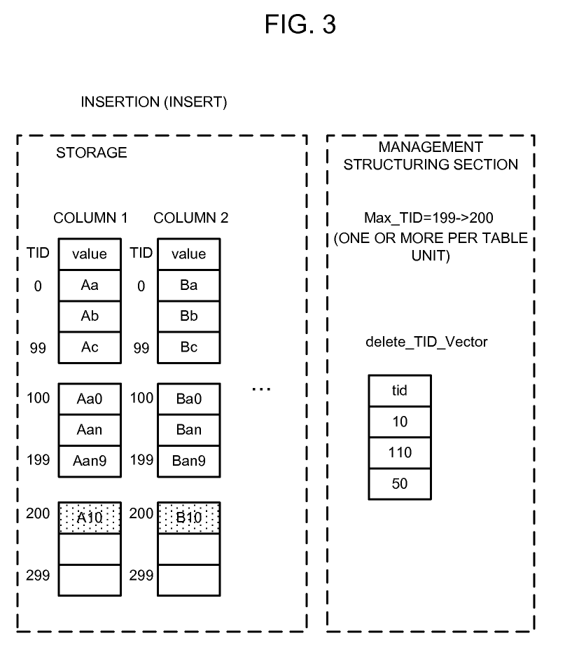

The above-mentioned inserting process will be specifically explained by referring to FIG. 3. It is assumed that tuples up to TID 199 exist in the storage 11, and TID 10, TID 110, and TID 50, out of them, have been recorded as data that has been already nullified with the operation so far performed. At this time, max_TID has been set as 199. The database arithmetic processing section 30 inputs new data as TID 200 into the storage 11 and alters max_TID of the management structuring section 12 to 200 when an inputting process for the storage 11 is completed.

The deleting process (DELETE) will be explained. When the database arithmetic processing section 30 nullifies a specific value for the storage 11, it additionally affixes a designated value to a deleted tuple array delete_TID_Vector of the management structuring section 12. At this time, an alteration process for the column storage is not performed, whereby other database processes such as the finding relating hereto can be performed simultaneously in parallel. Further, the inserting process of data can be also performed simultaneously.

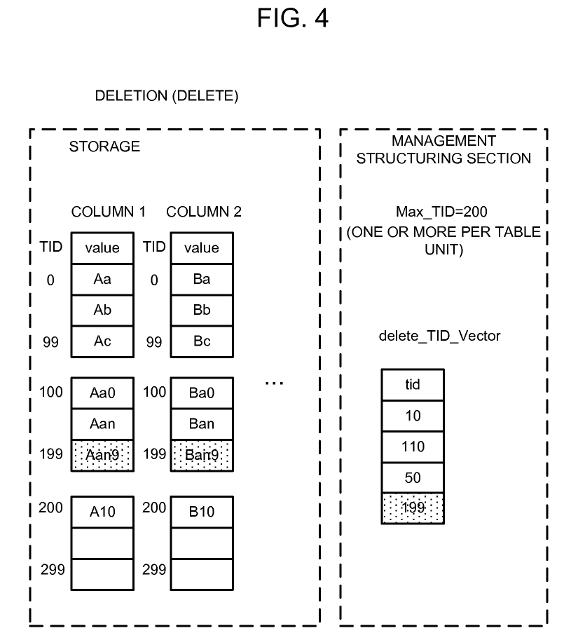

The above-mentioned deleting process will be specifically explained by referring to FIG. 4. It is assumed that tuples up to TID 200 exist in the storage 11, and TID 10, TID 110 and TID 50, out of them, have been recorded as data that has been already nullified with the operation so far performed. At this time, max_TID is set as 200. Herein, when data of TID 199 is deleted, the database arithmetic processing section 30 additionally affixes TID 199 (identification information of deletion-target data) of data to be nullified to the last end of delete_TID_Vector of the management structuring section 12.

The updating process (UPDATE) will be explained. The database arithmetic processing section 30 finds and specifies the tuple, being an update target, deletes the update-target tuple on top of preparing an updated tuple table, and inserts new tuple data. The updating process is realized by combining the finding, the deletion, and the insertion. At this time, data having TID smaller than the old max_TID is not altered, whereby other database processes such as the finding and the data deletion relating hereto can be performed simultaneously in parallel.

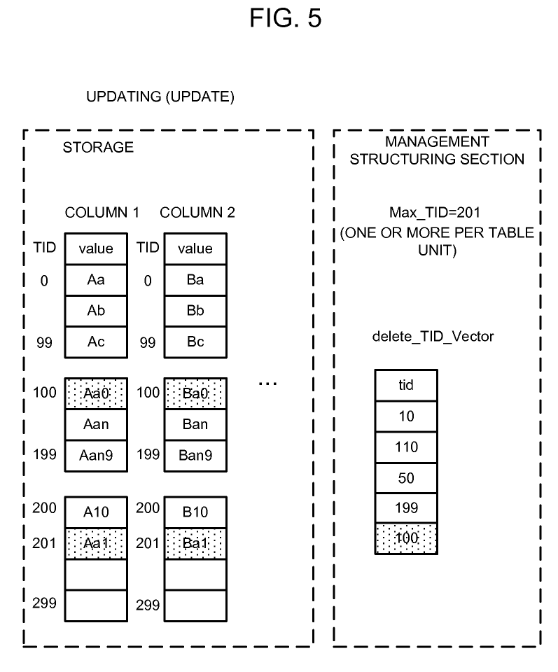

The above-mentioned updating process will be specifically explained by referring to FIG. 5. It is assumed that tuples up to TID 200 exist in the storage 11, and TID 10, TID 110, TID 50, and TID 199, out of them, have been recorded as data that has been already nullified with the operation so far performed. At this time, max_TID has been set as 200. When the database arithmetic processing section 30 updates data stored into TID 100, it deletes TID 100, and inputs new data as TID 201. Namely, the updating process is performed as a two-stage process of the deletion (DELETE) and the insertion (INSERT) so far explained.

The finding process (FIND) will be explained. The database arithmetic processing section 30 acquires max_TID from the management structuring section 12, and sets the region inside the column storage 11 less than the above TID as a finding region (finding range). Further, the database arithmetic processing section 30 acquires delete_TID_Vector from the management structuring section 12, and marks it as data to be excluded from the finding. The database arithmetic processing section 30 executes the finding process under a designated condition, and obtains a result, being a list of TIDs.

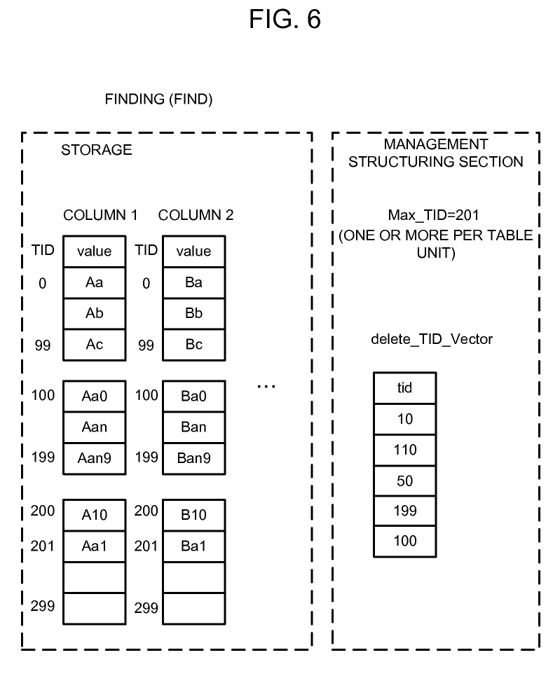

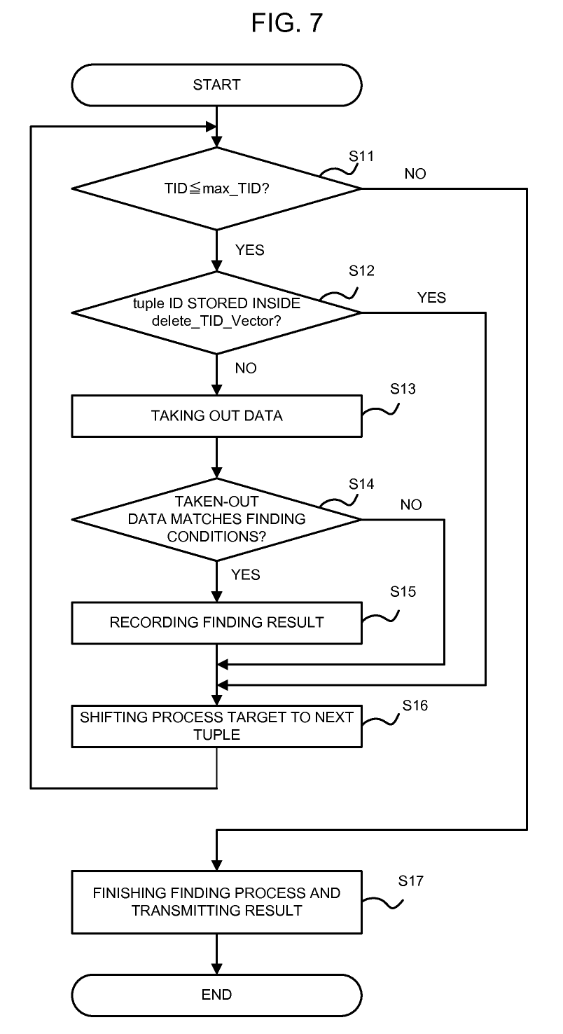

The above-mentioned finding process will be specifically explained by referring to FIG. 6. It is assumed that tuples up to TID 201 exist in the storage 11, and TID 10, TID 110, TID 50, TID 199, and TID 100, out of them, have been recorded as data that has been already nullified with the operation so far performed. At this time, max_TID has been set as 201. The finding at this time point is executed by regarding the tuples up to TID 201 as valid, and regarding TID 10, TID 110, TID 50, TID 199, and TID 100 recorded in delete TID Vector as invalid. Now, in the finding operation, an inspection as to whether the designated data of the column satisfies the designated condition is performed. An finding unit to be realized by the database arithmetic processing section 30 takes out the column designated by the storage 11, and in addition, performs a process of determining whether the tuple is valid from this. This process will be explained by referring to a flowchart of FIG. 7.

The database arithmetic processing section 30 determines whether, for a certain tuple, TID thereof is equal to or less than max_TID (step S11). When TID of the above tuple is larger than max_TID (step S11: NO) in this determination, the finding process is finished, and a finding result is transmitted to a requestor (step S17). Further, when TID of the above tuple is identical to or smaller than max_TID (step S11: YES), the inspection as to whether the tuple ID coinciding with the tuple ID of the process-target tuple is stored inside delete_TID_Vector is performed (step S12). When it is stored (step S12: YES), the process target is shifted to the next tuple (step S16). When it is not stored (step S12: NO), the process-target tuple is regarded as valid, and data stored into the above tuple is taken out (step S 13). And, an inspection as to whether the taken-out data matches the finding condition is performed (step S14), an inspection result thereof is recorded into a predetermined record region (step S15) when it matches (step S14: YES), the process target is shifted to the next tuple (step S16), and a flow returns to the step S11.

A plurality of finding queries can be simultaneously executed because an alteration to the structure in the inside of the database is not accompanied at all when this finding process is executed. Further, each query of the insertion, the deletion and the update can be simultaneously executed during execution of the finding query.

It is required to realize the high-speed processing because the database 10 keeps a large volume of tuples, and the data processing amount is increased, particularly, in the finding process. In this column store database, the parallel computation for the column storage with the parallel arithmetic unit makes it possible to realize the high-speed processing of the finding process etc.

There are many cases in which a result in the middle of the computation is used as a binary array for the tuple in a query computation of the database. With the case of this postscript-type column store database, it is also necessary to designate the deleted tuple and to exclude this from the query result. Also at this time, the binary array for the tuple is used. The parallel arithmetic unit is capable of executing generation and synthesis of the binary array at a high speed. In a case of applying a recent GPGPU (General Purpose Computing on Graphics Processing Unit) to this high-speed arithmetic operation, storing the storage and delete_TID_Vector in a memory in the GPU side and performing synthesis of the query results in the GPU side makes it possible to exhibit the high-speed processing.

The present invention is suitable for utilization in a field in which a high-volume updating process is required and yet a high-speed prompt analysis is performed.

As explained above, the present invention includes max_TID indicative of the valid data range at a certain time point and delete_TID_Vector indicative of the data position that is already invalid, for the database into which data is stored in a unit of the column, and assumes a postscript-type configuration, thereby enabling an exclusive control range for the database to be lessened, and parallelism of the processing to be enhanced.

### Second Exemplary Embodiment

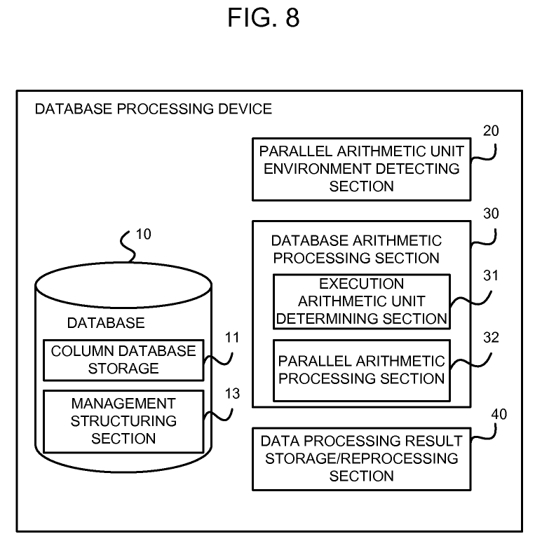

FIG. 8 is a view illustrating a configuration of the database processing device relating to the second exemplary embodiment of the present invention. The database processing device of the second exemplary embodiment, which is configured of a computer including a CPU, a parallel arithmetic unit such as a GPU, and a a storage device etc. The database processing device includes a database 10, a parallel arithmetic unit environment detecting section 20, a database arithmetic processing section 30, and a data processing result storing/reprocessing section 40. Each constituent element of the second exemplary embodiment is almost identical to the constituent element that corresponds in the first exemplary embodiment. Hereinafter, a difference with the first exemplary embodiment will be focused and explained.

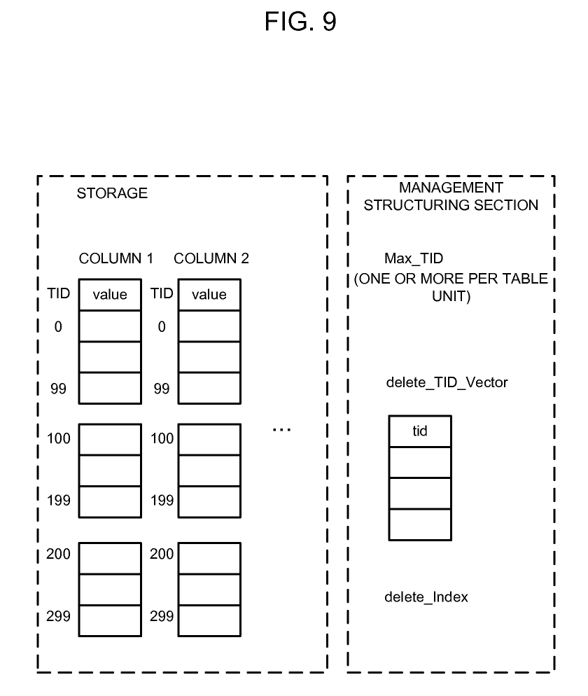

A structure of the database 10 is exemplified in FIG. 9. As shown in the figure, the database 10 includes a column database (storage) 11 in which only the additional affixing is permitted, and a management structuring section 13 for management in a unit of the table. The management structuring section 13 stores data of a latest tuple position (max_TID) indicative of the position to be regarded as valid at a certain time point, data of a deleted tuple array (delete_TID_Vector) indicative of an array of tuple IDs deleted so far as identification information (a second information) of the tuples that are already invalid, and information indicative of a valid range of the information to be additionally affixed to the aforementioned second information, namely, a valid position (deletelndex) of the deleted tuple ID array (delete_TID_Vector).

Next, an operation of the database processing device relating to this exemplary embodiment will be explained. Processes to be performed for the database 10 are insertion (INSERT) of data, deletion (DELETE), updating (UPDATE), finding (FIND), computation for the finding result (Func), and re-processing (INSERT, DELETE, UPDATE).

The inserting process (INSERT) will be explained. The database arithmetic processing section 30 issues to the storage 11 TIDs (tuple IDs) of which number is identical to the number of data to be newly inserted, and additionally affixes data to the storage end. And, when the additional affixing of the tuples to all columns for which the additional affixing should be performed is completed, the database arithmetic processing section 30 updates the latest tuple position max_TID of the management structuring section 13 with a value obtained by performing the addition by the number equivalent to the number of the data for which the additional affixing has been performed. At this time, data having TID smaller than the old max_TID is not altered, whereby other database processes such as the finding and the data deletion relating hereto can be performed simultaneously in parallel.

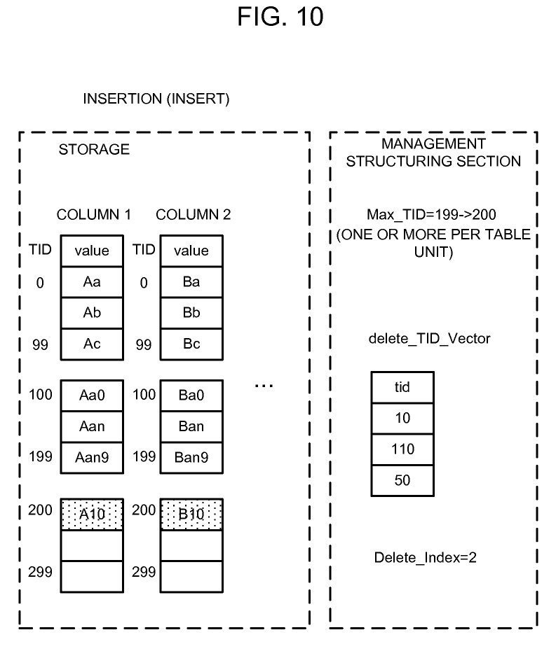

The above-mentioned inserting process will be specifically explained by referring to FIG. 10. It is assumed that tuples up to TID 199 exist in the storage 11, and TID 10, TID 110 and TID 50, out of them, have been recorded as data that has been already nullified with the operation so far performed. At this time, max_TID has been set as 199. Further, deletelndex indicates 2 (initial value: 0). The database arithmetic processing section 30 inputs new data into the storage 11 as TID 200 and alters max_TID of the management structuring section 13 to 200 when an inputting process for the storage 11 is completed.

The deleting process (DELETE) will be explained. When the database arithmetic processing section 30 nullifies a specific value for the storage 11, it additionally affixes a designated value to the deleted tuple array delete_TID_Vector of the management structuring section 13. Further, the database arithmetic processing section 30 adds 1 to deletelndex. At this time, an alteration to the column storage is not performed, whereby other read only processes such as the finding relating hereto can be performed simultaneously in parallel. Further, the insertion of data can be also performed simultaneously.

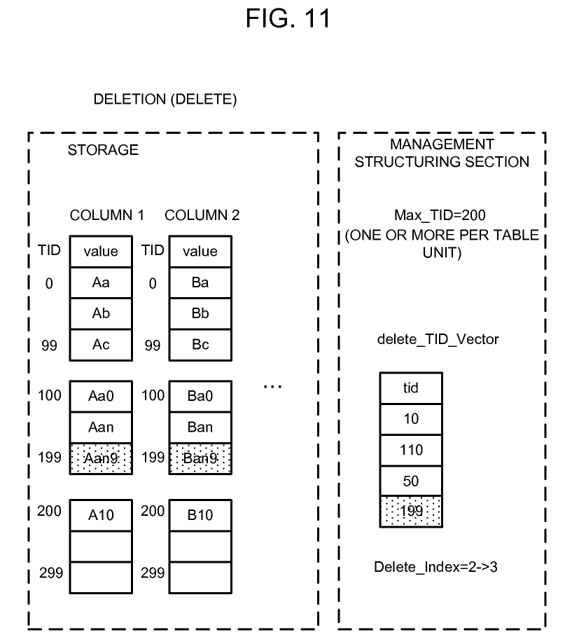

The above-mentioned deleting process will be specifically explained by referring to FIG. 11. It is assumed that tuples up to TID 200 exist in the storage 11, and TID 10, TID 110 and TID 50, out of them, have been recorded as data that has been already nullified with the operation (deletion) so far performed. At this time, max_TID has been set as 200. Herein, when data of TID 199 is deleted, the database arithmetic processing section 30 additionally affixes TID 199 (identification information of the deletion-target data) of data that is nullified to the last end of deleteTID_Vector of the management structuring section 13. Further, the database arithmetic processing section 30 adds 1 to 2 of deletelndex to yield 3 so that the additionally affixed information falls under in a valid range.

The updating process (UPDATE) will be explained. The database arithmetic processing section 30 specifies the tuple, being an update-target, deletes the update-target tuple on top of preparing the updated tuple data, and inserts new tuple data. The updating process is realized by combining the finding, the deletion, and the insertion. At this time, data having TID smaller than the old max_TID is not altered, whereby other database processes such as the finding and the data deletion relating hereto can be performed simultaneously in parallel.

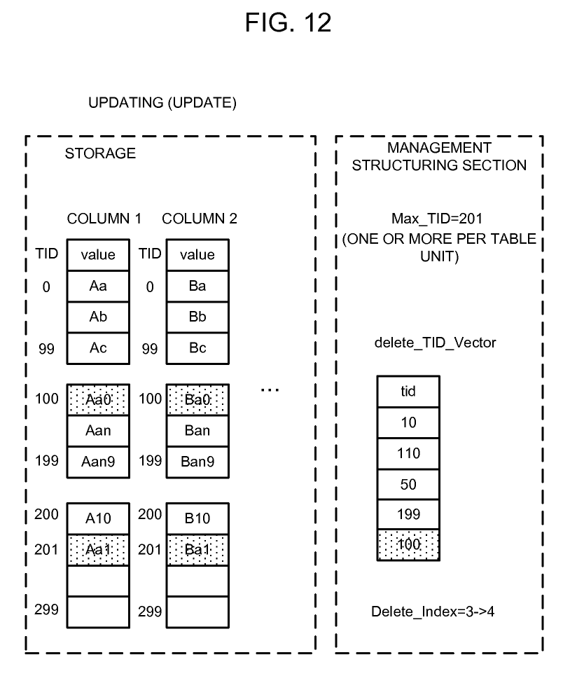

The above-mentioned updating process will be specifically explained by referring to FIG. 12. It is assumed that tuples up to TID 200 exist in the storage 11, and TID 10, TID 110, TID 50, and TID 199, out of them, have been recorded as data that has been already nullified with the operation so far performed. At this time, max_TID has been set as 200. When the database arithmetic processing section 30 updates data stored into TID 100, it deletes TID 100, and inputs new data as TID 201. In this case, the database arithmetic processing section 30 additionally affixes TID 100 of data that is nullified to the last end of deleteTID_Vector of the management structuring section 13, and adds 1 to 3 of deletelndex to yield 4. Further, the database arithmetic processing section 30 alters max_TID to 201. Namely, the updating process is performed as a two-stage process of the deletion (DELETE) and the insertion (INSERT) so far explained.

The finding process (FIND) will be explained. The database arithmetic processing section 30 acquires max_TID from the management structuring section 13, and sets the region inside the column storage 11 less than the above TID as a finding region. Further, the database arithmetic processing section 30 acquires delete_TID_Vector from the management structuring section 13, and marks it as data to be excluded from the finding on top of detecting the valid deletion position from deletelndex. The database arithmetic processing section 30 executes the finding process under a designated condition, and obtains a result, being a list of TIDs.

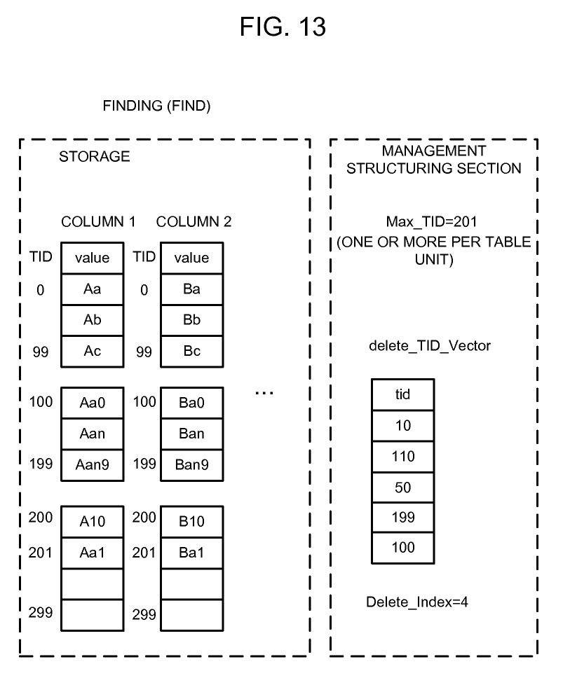

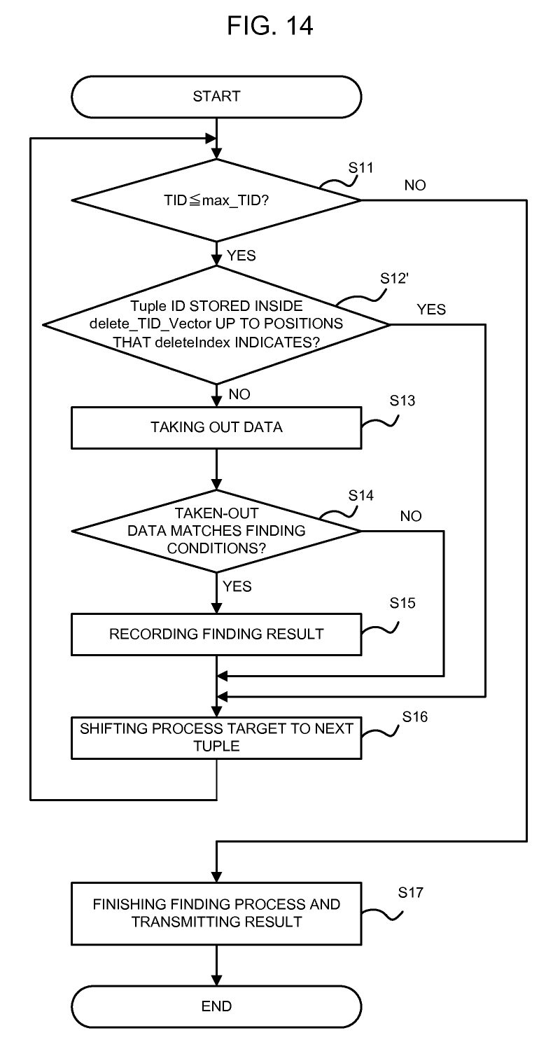

The above-mentioned finding process will be specifically explained by referring to FIG. 13. It is assumed that tuples up to TID 201 exist in the storage 11, and TID 10, TID 110, TID 50, TID 199, and TID 100, out of them, have been recorded as data that has been already nullified with the operation so far performed. At this time, max_TID has been set as 201. The finding at this time point is executed by regarding the tuples up to TID 201 as valid, and regarding the tuples of TID 10, TID 110, TID 50, TID 199, and TID 100 as invalid that have been recorded in deleteTID_Vector and yet are less than deletelndex. Now, in the finding operation, an inspection as to whether the designated data of the column satisfies the designated condition is performed. An finding unit to be realized by the database arithmetic processing section 30 takes out the column designated by the storage 11, and in addition, performs a process of determining whether the tuple is valid from this. A flowchart of this process is shown in FIG. 14. A difference with the process of the first exemplary embodiment shown in FIG. 7 is step 12′. In the step S12′, the database arithmetic processing section 30 inspects whether the tuple ID coinciding with the tuple ID of the process-target tuple is stored inside delete_TID_Vector up to the valid positions that deletelndex indicates.

A plurality of the finding queries can be simultaneously executed because an alteration to the structure in the inside of the database is not accompanied at all when this finding process is executed. Further, each query of the insertion, the deletion and the update can be simultaneously executed during execution of the finding query.

It is required to realize the high-speed processing because the database 10 keeps a large volume of the tuples, and the data processing amount is increased, particularly, in the finding process. In this column store database, the parallel computation for the column storage with the parallel arithmetic unit makes it possible to realize the high-speed processing of the finding process etc.

There are many cases in which a result in the middle of the computation is used as a binary array for the tuple in a query computation of the database. With the case of this postscript-type column store database, it is also necessary to designate the deleted tuple and to exclude this from the query result. Also at this time, the binary array for the tuple is used. The parallel arithmetic unit is capable of executing generation and synthesis of the binary array at a high speed. In a case of applying a recent GPGPU to this high-speed arithmetic operation, storing the storage and deleteTID_Vector in a memory in the GPU side and performing synthesis of the query results in the GPU side makes it possible to exhibit the high-speed processing.

The present invention is suitable for utilization in a field in which a high-volume updating process is required and yet a high-speed prompt analysis is performed.

As explained above, the present invention includes max_TID indicative of the valid data range at a certain time point, delete_TID_Vector indicative of the data position for identifying the data that is already invalid, and deleteindex indicative of the valid position of delete TID Vector for the database into which data is stored in a unit of the column, and assumes a postscript-type configuration, thereby enabling an exclusive control range for the database to be furthermore lessened, and parallelism of the process to be enhanced.

Because a deletion list has a postscript-type structure, and is locked less, it may be enough to lock and acquire the deletion list at the time of initializing transaction execution, to progress the read query without the lock from this on. In case of the write query accompanying the deletion, at the time of the writing, the deletion list is locked to acquire the valid position of the deletion list, to perform the additionally affixing to update the valid position, and then is canceled the lock. This enables the rock time of the deletion list to be reduced.

Additionally, in the above-mentioned explanation, the database processing device is configured to include the database 10; however, the configuration of the database processing device is not limited hereto, and for example, the database processing device may be configured in such a manner that the database 10 is installed onto another storage device, and this storage device and the above-mentioned database processing device are connected via a network etc.

The database processing device relating to the exemplary embodiments of the present invention described above may be realized by loading and executing, by the CPU of this device, an operational program etc. stored into the storage device and the recording medium, and further, may be configured with hardware. Only a function of one part of the above-mentioned exemplary embodiments can be realized with a computer program, and can be also stored into the storage device and the recording medium.

Above, while the present invention has been particularly shown and described with reference to preferred exemplary embodiments, the present invention is not limited to the above mentioned exemplary embodiments. It will be understood by those of ordinary skill in the art that various changes in form and details may be made therein without departing from the spirit and scope of the present invention.

The whole or part of the exemplary embodiments disclosed above can be described as, but not limited to, the following supplementary note.

(Supplementary Note 1)

A database processing device, including:

a column store database including a storage into which tuple data is stored in a unit of a column and a management structuring section into which first information indicative of a valid data range and second information comprised of identification information of data that is already invalid are stored in terms of the aforementioned storage; and

a database processing section that, when performing a process of inserting data for the aforementioned column store database, additionally affixes the aforementioned data to an end of the aforementioned storage and updates the aforementioned first information of the aforementioned management structuring section, and when performing a process of deleting data for the aforementioned column store database, additionally affixes identification information of deletion-target data to the aforementioned second information of the aforementioned management structuring section.

(Supplementary Note 2)

The database processing device according to the supplementary note 1, wherein the aforementioned database processing section decides, based on information stored into the aforementioned management structuring section, an exclusive control range for the aforementioned column store database that is employed at the time of updating the aforementioned column store database.

(Supplementary Note 3)

The database processing device according to the supplementary note 1 or the supplementary note 2, further including an execution arithmetic unit determining section that determines whether or not a requested arithmetic process is executed by employing a parallel arithmetic unit, and causes the aforementioned parallel arithmetic unit to execute the aforementioned requested arithmetic process when it has been determined that the requested arithmetic process is executed by employing the parallel arithmetic unit.

(Supplementary Note 4)

The database processing device according to one of the supplementary note 1 to the supplementary note 3, wherein when the aforementioned database processing section performs a process of finding data for the aforementioned column store database, it decides a finding range based on the aforementioned first information of the aforementioned management structuring section, and specifies data to be excluded from the finding based on the aforementioned second information to find data.

(Supplementary Note 5)

The database processing device according to one of the supplementary note 1 to the supplementary note 4, wherein when the aforementioned database processing section performs a process of updating data for the aforementioned column store database, it finds update-target data, performs the aforementioned deleting process for the found update-target data, and performs the aforementioned inserting process for data prepared for updating.

(Supplementary Note 6)

The database processing device according to one of the supplementary note 1 to the supplementary note 3:

wherein third information indicative of a valid range of information to be additionally affixed to the aforementioned second information is further stored into the aforementioned management structuring section; and

wherein when the aforementioned database processing section performs a process of deleting data for the aforementioned column store database, it additionally affixes identification information of deletion-target data to the aforementioned second information of the aforementioned management structuring section, and updates the aforementioned third information so that the above additionally affixed information falls under a valid range.

(Supplementary Note 7)

The database processing device according to the supplementary note 6, wherein when the aforementioned database processing section performs a process of finding data for the aforementioned column store database, it decides a finding range based on the aforementioned first information of the aforementioned management structuring section, and specifies data to be excluded from the finding based on the aforementioned second information and the aforementioned third information to find data.

(Supplementary Note 8)

The database processing device according to the supplementary note 7, wherein when the aforementioned database processing section performs a process of updating data for the aforementioned column store database, it finds update-target data, performs the aforementioned deleting process for the found update-target data, and performs the aforementioned inserting process for data prepared for updating.

(Supplementary Note 9)

A database processing method including:

when performing a process of inserting data for a column store database including a storage into which tuple data is stored in a unit of a column and a management structuring section into which first information indicative of a valid data range and second information comprised of identification information of data that is already invalid are stored in terms of the above-mentioned storage, additionally affixing the aforementioned data to an end of the aforementioned storage and updating the aforementioned first information of the aforementioned management structuring section; and

when performing a process of deleting data for the aforementioned column store database, additionally affixing identification information of deletion-target data to the aforementioned second information of the aforementioned management structuring section.

(Supplementary Note 10)

The database processing method according to the supplementary note 9, including deciding, based on information stored into the aforementioned management structuring section, an exclusive control range for the aforementioned column store database that is employed at the time of updating the aforementioned column store database.

(Supplementary Note 11)

The database processing method according to the supplementary note 9 or the supplementary note 10, including determining whether or not a requested arithmetic process is executed by employing a parallel arithmetic unit, and causing the aforementioned parallel arithmetic unit to execute the aforementioned requested arithmetic process when it has been determined that the arithmetic process is executed by employing the parallel arithmetic unit.

(Supplementary Note 12)

The database processing method according to one of the supplementary note 9 to the supplementary note 11, including, when performing a process of finding data for the aforementioned column store database, deciding a finding range based on the aforementioned first information of the aforementioned management structuring section, and specifying data to be excluded from the finding based on the aforementioned second information to find data.

(Supplementary Note 13)

The database processing method according to one of the supplementary note 9 to the supplementary note 12, including, when performing a process of updating data for the aforementioned column store database, finding update-target data, performing the aforementioned deleting process for the found update-target data, and performing the aforementioned inserting process for data prepared for updating.

(Supplementary Note 14)

The database processing method according to one of the supplementary note 9 to the supplementary note 11, wherein third information indicative of a valid range of information to be additionally affixed to the aforementioned second information is further stored into the aforementioned management structuring section, the aforementioned database processing method including, when performing a process of deleting data for the aforementioned column store database, additionally affixing identification information of deletion-target data to the aforementioned second information of the aforementioned management structuring section, and updating the aforementioned third information so that the above additionally affixed information falls under a valid range.

(Supplementary Note 15)

The database processing method according to the supplementary note 14, including, when performing a process of finding data for the aforementioned column store database, deciding a finding range based on the aforementioned first information of the aforementioned management structuring section, and specifying data to be excluded from the finding based on the aforementioned second information and the aforementioned third information to find data.

(Supplementary Note 16)

The database processing method according to the supplementary note 15, including, when performing a process of updating data for the aforementioned column store database, finding update-target data, performing the aforementioned deleting process for the found update-target data, and performing the aforementioned inserting process for data prepared for updating. (Supplementary Note 17)

A program for causing a computer to execute:

a process of, when performing a process of inserting data for a column store database including a storage into which tuple data is stored in a unit of a column and a management structuring section into which first information indicative of a valid data range and second information comprised of identification information of data that is already invalid are stored in terms of the aforementioned storage, additionally affixing the aforementioned data to an end of the aforementioned storage and updating the aforementioned first information of the aforementioned management structuring section; and

a process of, when performing a process of deleting data for the aforementioned column store database, additionally affixing identification information of deletion-target data to the aforementioned second information of the aforementioned management structuring section.

(Supplementary Note 18)

The program according to the supplementary note 17, causing the aforementioned computer to execute a process of deciding, based on information stored into the aforementioned management structuring section, an exclusive control range for the aforementioned column store database that is employed at the time of updating the aforementioned column store database.

(Supplementary Note 19)

The program according to the supplementary note 17 or the supplementary note 18, causing the aforementioned computer to execute a process of determining whether or not a requested arithmetic process is executed by employing a parallel arithmetic unit, and causing the aforementioned parallel arithmetic unit to execute the aforementioned requested arithmetic process when it has been determined that the arithmetic process is executed by employing the parallel arithmetic unit.

(Supplementary Note 20)

The program according to one of the supplementary note 17 to the supplementary note 19, causing the aforementioned computer to execute a process of, when performing a process of finding data for the aforementioned column store database, deciding a finding range based on the aforementioned first information of the aforementioned management structuring section, and specifying data to be excluded from the finding based on the aforementioned second information to find data.

(Supplementary Note 21)

The program according to one of the supplementary note 17 to the supplementary note 20, causing the aforementioned computer to execute a process of, when performing a process of updating data for the aforementioned column store database, finding update-target data, performing the aforementioned deleting process for the found update-target data, and performing the aforementioned inserting process for data prepared for updating.

(Supplementary Note 22)

The program according to one of the supplementary note 17 to the supplementary note 19: wherein third information indicative of a valid range of information to be additionally affixed to the aforementioned second information is further stored into the aforementioned management structuring section; and

wherein the aforementioned deleting process additionally affixes identification information of deletion-target data to the aforementioned second information of the aforementioned management structuring section, and updates the aforementioned third information so that the above additionally affixed information falls under a valid range.

(Supplementary Note 23)

The program according to the supplementary note 22, causing the aforementioned computer to execute a process of, when performing a process of finding data for the aforementioned column store database, deciding a finding range based on the aforementioned first information of the aforementioned management structuring section, and specifying data to be excluded from the finding based on the aforementioned second information and the aforementioned third information to find data.

(Supplementary Note 24)

The program according to the supplementary note 23, causing the aforementioned computer to execute a process of, when performing a process of updating data for the aforementioned column store database, finding update-target data, performing the aforementioned deleting process for the found update-target data, and performing the aforementioned inserting process for data prepared for updating.

(Supplementary Note 25)

A data structure of a column store database including:

a storage into which tuple data is stored in a unit of a column; and

a management structuring section into which first information indicative of a valid data range and second information indicative of data that is already invalid are stored in terms of the aforementioned storage.

(Supplementary Note 26)

The data structure of the column store database according to the supplementary note 25, wherein third information indicative of a valid range of information to be additionally affixed to the aforementioned second information is further stored into the aforementioned management structuring section.

What is claimed is:

1. A database processing device comprising:
a column store database comprising a storage into which tuple data is stored in a unit of a column and a management structuring section into which first information indicative of a valid data range and second information comprised of identification information of data that is already invalid are stored in terms of said storage; and
a database processing section that, when performing a process of inserting data for said column store database, additionally affixes said data to an end of said storage and updates said first information of said management structuring section, and when performing a process of deleting data for said column store database, additionally affixes identification information of deletion-target data to said second information of said management structuring section.

2. The database processing device according to claim 1, wherein said database processing section decides an exclusive control range for said column store database based on information stored into said management structuring section, said exclusive control range being employed at the time of updating said column store database.

3. The database processing device according to claim 1, further comprising an execution arithmetic unit determining section that determines whether or not a requested arithmetic process is executed by employing a parallel arithmetic unit, and causes said parallel arithmetic unit to execute said requested arithmetic process when it has been determined that the requested arithmetic process is executed by employing the parallel arithmetic unit.

4. The database processing device according to claim 1, wherein when said database processing section performs a process of finding data for said column store database, it decides a finding range based on said first information of said management structuring section, and specifies data to be excluded from the finding based on said second information to find data.

5. The database processing device according to claim 1, wherein when said database processing section performs a process of updating data for said column store database, it finds update-target data, performs said deleting process for the found update-target data, and performs said inserting process for data prepared for updating.

6. The database processing device according to claim 1:
wherein third information indicative of a valid range of information to be additionally affixed to said second information is further stored into said management structuring section; and
wherein when said database processing section performs a process of deleting data for said column store database, it additionally affixes identification information of deletion-target data to said second information of said management structuring section, and updates said third information so that the above additionally affixed information falls under a valid range.

7. The database processing device according to claim 6, wherein when said database processing section performs a process of finding data for said column store database, it decides a finding range based on said first information of said management structuring section, and specifies data to be excluded from the finding based on said second information and said third information to find data.

8. The database processing device according to claim 7, wherein when said database processing section performs a process of updating data for said column store database, it finds update-target data, performs said deleting process for the found update-target data, and performs said inserting process for data prepared for updating.

9. A database processing method, comprising:
when performing a process of inserting data for a column store database including a storage into which tuple data is stored in a unit of a column and a management structuring section into which first information indicative of a valid data range and second information comprised of identification information of data that is already invalid are stored in terms of said storage, additionally affixing said data to an end of said storage and updating said first information of said management structuring section; and
when performing a process of deleting data for said column store database, additionally affixing identification information of deletion-target data to said second information of said management structuring section.

10. The database processing method according to claim 9, wherein third information indicative of a valid range of information to be additionally affixed to said second information is further stored into said management structuring section, said database processing method comprising, when performing a process of deleting data for said column store database, additionally affixing identification information of deletion-target data to said second information of said management structuring section, and updating said third information so that the above additionally affixed information falls under a valid range.

11. A non-transitory computer readable storage medium having a program stored therein for causing a computer to execute:
a process of, when performing a process of inserting data for a column store database including a storage into which tuple data is stored in a unit of a column and a management structuring section into which first information indicative of a valid data range and second information comprised of identification information of data that is already invalid are stored in terms of said storage, additionally affixing said data to an end of said storage and updating said first information of said management structuring section; and
a process of, when performing a process of deleting data for said column store database, additionally affixing identification information of deletion-target data to said second information of said management structuring section.

12. The non-transitory computer readable storage medium according to claim 11:
wherein third information indicative of a valid range of information to be additionally affixed to said second information is further stored into said management structuring section; and
wherein said deleting process additionally affixes identification information of deletion-target data to said second information of said management structuring section, and updates said third information so that the above additionally affixed information falls under a valid range.
